(19) United States
(12) Patent Application Publication
(10) Pub. No.: US 2026/0004484 A1
(43) Pub. Date: Jan. 1, 2026

(54) OBJECT ARRANGEMENT APPARATUS AND METHOD

(71) Applicants: HYUNDAI MOTOR COMPANY, Seoul (KR); KIA CORPORATION, Seoul (KR)

(72) Inventor: Subin Cho, Hwaseong-si (KR)

(73) Assignees: HYUNDAI MOTOR COMPANY, Seoul (KR); KIA CORPORATION, Seoul (KR)

(21) Appl. No.: 18/970,363

(22) Filed: Dec. 5, 2024

(30) Foreign Application Priority Data
Jul. 1, 2024 (KR) 10-2024-0086160

(51) Int. Cl. G06T 11/20

(52) U.S. Cl. CPC G06T 11/206

(57) ABSTRACT

In an object arrangement apparatus and method, the object arrangement apparatus includes a data manager configured to manage object data including information on identifiers, sizes and an arrangement order of objects, and set box data including information on types and sizes of set boxes, a data preprocessor configured to determine a type of a set box in which each object is arrangeable, based on the object data and the set box data, and perform preprocessing on the object data, and an object arranger configured to determine a set box in which an object is arranged depending on the arrangement order of the objects, based on the preprocessed object data and the set box data, and perform arrangement of the object in the determined set box.

### CROSS-REFERENCE TO RELATED PATENT APPLICATION

The present application claims priority to Korean Patent Application No. 10-2024-0086160, filed on Jul. 1, 2024, the entire contents of which is incorporated herein for all purposes by this reference.

### BACKGROUND OF THE PRESENT DISCLOSURE

### Field of the Present Disclosure

The present disclosure relates to an object arrangement apparatus and method, and more particularly, to an object arrangement apparatus and method for optimally arranging one or more objects in one or more set boxes.

### Description of Related Art

Factories that flexibly produce multiple types of vehicles often adopt cell production and one-kit logistics systems to secure logistics flexibility. The one-kit logistics system is a logistics system that introduces a vehicle, set boxes, in which all parts to be assembled with the corresponding vehicle are placed, and loading racks, and supplies the parts in a timely manner while moving the vehicle, so that multiple types of vehicles may be produced on a single line.

In the case of conventional technology, part arrangement in a set box may be performed by organizing parts depending on a process, setting a set box and a loading rack that are capable of responding to the process, and determining the most optimized arrangement after arranging actual parts in the set box in various directions.

However, the present method had the problem that it took too much time for preliminary verification in which the actual parts are arranged in the set box, and particularly, in the flexible production concept, if part organization for the corresponding process is changed, a set box must be selected again and the optimized arrangement of parts must be determined, and thus a verification time was too long and real-time response was difficult.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an object arrangement apparatus and method which may respond in real time to a change in object organization for an arbitrary process by rapidly modeling and optimizing arrangement of objects (e.g., parts) in a set box.

It is another object of the present disclosure to provide an object arrangement apparatus and method that may determine a set box in which each object is to be arranged depending on the arrangement order (e.g., work order) of objects and optimally arrange the objects in the corresponding set box.

It is yet another object of the present disclosure to provide an object arrangement apparatus and method in which objects are arranged so that an empty space in a set box is minimized using an optimal object arrangement algorithm.

Objects of the present disclosure are not limited to the above-mentioned object, and other objects and advantages of the present disclosure, which are not mentioned, will be understood through the following description, and will become apparent from embodiments of the present disclosure. It is also to be understood that the objects and advantages of the present disclosure may be realized by means and combinations thereof set forth in claims.

In accordance with one aspect of the present disclosure, the above and other objects may be accomplished by the provision of an object arrangement apparatus including a data manager configured to manage object data including information on identifiers, sizes and an arrangement order of objects, and set box data including information on types and sizes of set boxes, an object data preprocessor configured to determine a type of a set box in which each object is arrangeable, based on the object data and the set box data, and perform preprocessing on the object data, and an object arranger configured to determine a set box in which an object is arranged depending on the arrangement order of the objects, based on the preprocessed object data and the set box data, and perform arrangement of the object in the determined set box.

The object arrangement apparatus may further include an object arrangement reviewer configured to review whether all objects required for the corresponding process have been arranged in one or more set boxes, and an object arrangement visualizer configured to visualize arrangement of one or more objects in the one or more set boxes.

The object date preprocessor is configured to determine that the object is arrangeable in the set box, if a shortest length of the object is not greater than a loadable height of the set box, a longest length of the object is not greater than a longest length of a loading surface of the set box, and a middle length of the object is not greater than a shortest length of the loading surface of the set box, and may include information on the type of the set box in which the object is arrangeable in the object data.

The object arranger may be configured to determine a set box in which each object is to be arranged depending on the arrangement order of the objects and arranges the object, using an object arrangement algorithm, wherein the object arranger may, if an object to be currently arranged is arrangeable in a set box in which object arrangement is currently in progress, determine the set box in which the object arrangement is currently in progress as a set box in which the object to be currently arranged is to be arranged, and arrange the object to be currently arranged in determined the set box, and may, if the object to be currently arranged is not arrangeable in the set box in which the object arrangement is currently in progress, terminate the object arrangement in the set box in which the object arrangement is currently in progress, determine a new set box in which the object to be currently arranged is arrangeable as a set box in which the object to be currently arranged is to be arranged, and arrange the object to be currently arranged in the new set box.

The object arrangement algorithm may be configured to, when selecting a space of the set box in which the object is to be arranged, select a smallest area out of the loading surface of the set box, to which a rectangle formed by a longest length and a middle length of the object belongs, and arrange the object so that a horizontal or vertical remaining length of the selected area out of the loading surface of the set box is minimized.

In accordance with another aspect of the present disclosure, there is provided an object arrangement method including, based on object data including information on identifiers, sizes and an arrangement order of objects, and set box data including information on types and sizes of set boxes, determining a type of a set box in which each object is arrangeable and performing preprocessing on the object data, and determining a set box in which an object is arranged depending on the arrangement order of the objects, based on the preprocessed object data and the set box data, and performing arrangement of the object in the determined set box.

The object arrangement method may further include reviewing whether all objects required for the corresponding process have been arranged in one or more set boxes, and visualizing arrangement of one or more objects in the one or more set boxes, if all the objects required for the corresponding process have been arranged in one or more set boxes.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram of an object arrangement apparatus according to an exemplary embodiment of the present disclosure;

FIG. 2 is a flowchart of an object arrangement method according to an exemplary embodiment of the present disclosure;

FIG. 3 is a diagram showing object data according to an exemplary embodiment of the present disclosure;

FIG. 4 is a diagram explaining a method of defining the size of an object according to an exemplary embodiment of the present disclosure;

FIG. 5 is a diagram showing set box data according to an exemplary embodiment of the present disclosure;

FIG. 6 is a detailed flowchart showing Operation S210 of FIG. 2, illustrating an object data preprocessing method according to an exemplary embodiment of the present disclosure;

FIG. 7 is a detailed flowchart showing Operation S220 of FIG. 2, illustrating an object arrangement method according to an exemplary embodiment of the present disclosure; and

FIG. 8A, FIG. 8B and FIG. 8C are diagrams illustrating an object arrangement algorithm according to various exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, reference will be made in detail to exemplary embodiments of the present disclosure, examples of which are illustrated in the accompanying drawings and described below, and wherever possible, the same or similar elements will be denoted by the same reference numerals even though they are depicted in different drawings and a redundant description thereof will thus be omitted. In the following description of the embodiments, suffixes, such as “module”, and “part”, are provided or used interchangeably merely in consideration of ease in statement of the specification, and do not have meanings or functions distinguished from one another. In the following description of the exemplary embodiments of the present disclosure, a detailed description of known functions and configurations incorporated herein will be omitted when it may make the subject matter of the present disclosure rather unclear. Furthermore, the accompanying drawings will be exemplarily provided to describe the exemplary embodiments of the present disclosure, and should not be construed as being limited to the exemplary embodiments set forth herein, and it will be understood that the exemplary embodiments of the present disclosure are provided only to completely disclose the present disclosure and cover modifications, equivalents or alternatives which come within the scope and technical range of the present disclosure.

In the following description of the embodiments, terms, such as “first” and “second”, are used only to describe various elements, and these elements should not be construed as being limited by these terms. These terms are used only to distinguish one element from other elements.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present.

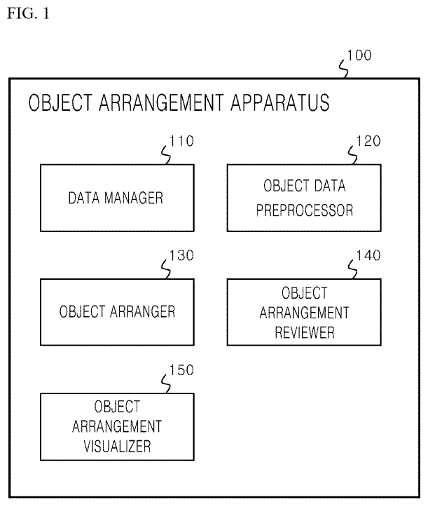

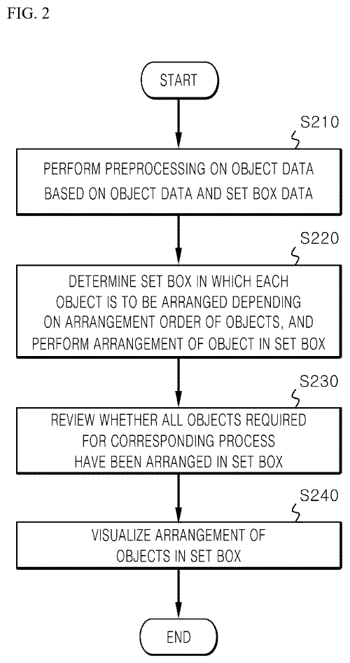

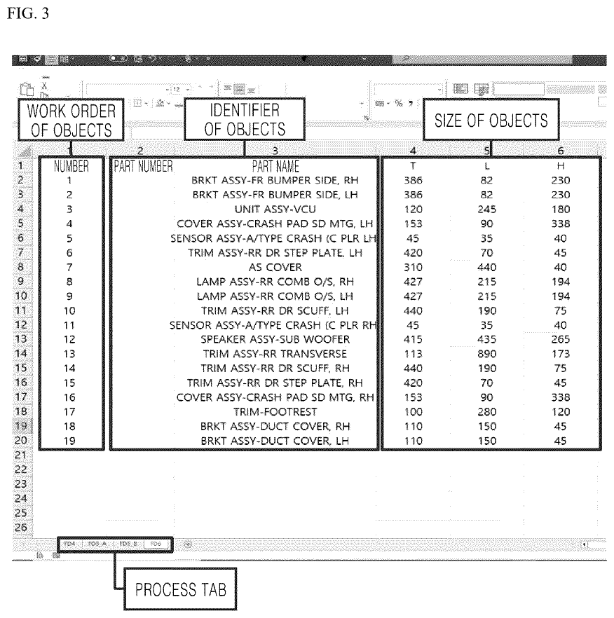

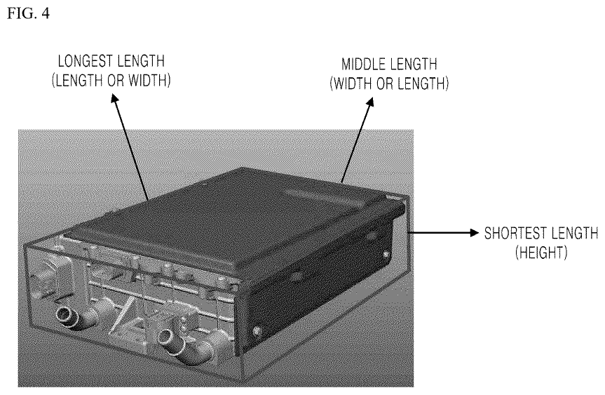

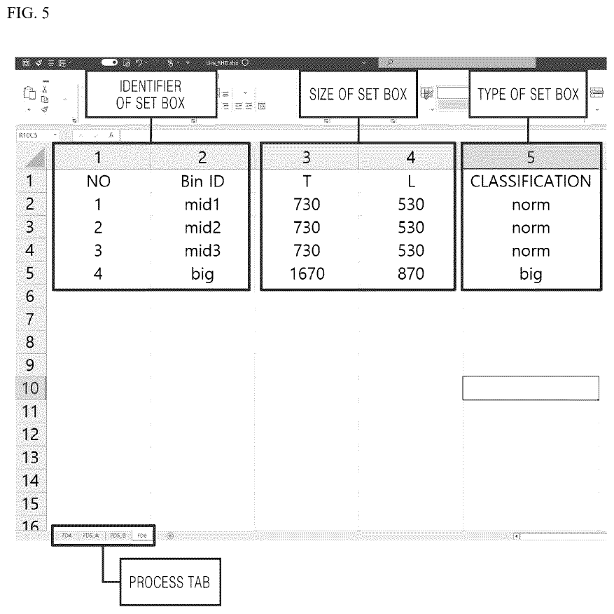

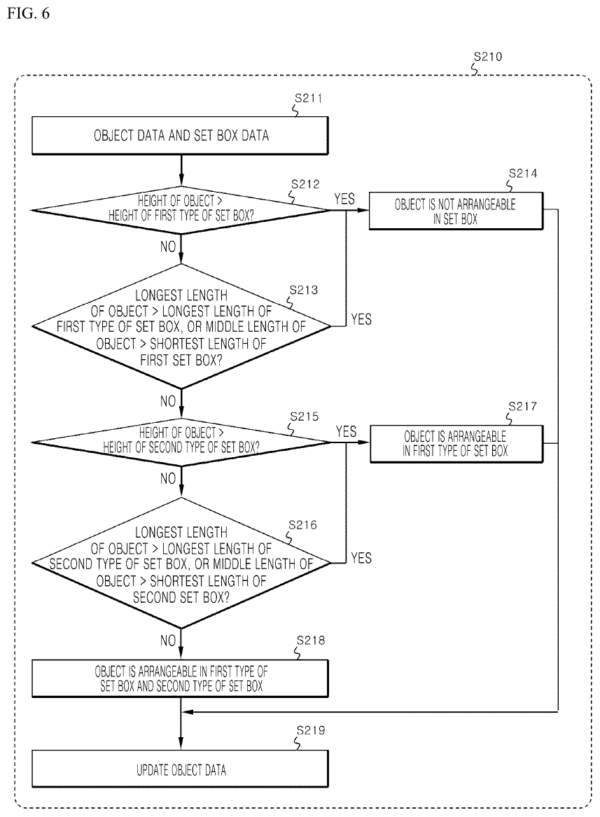

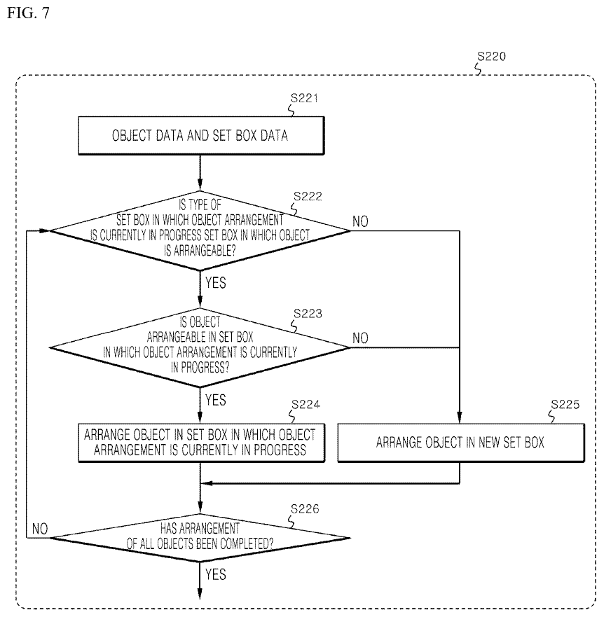

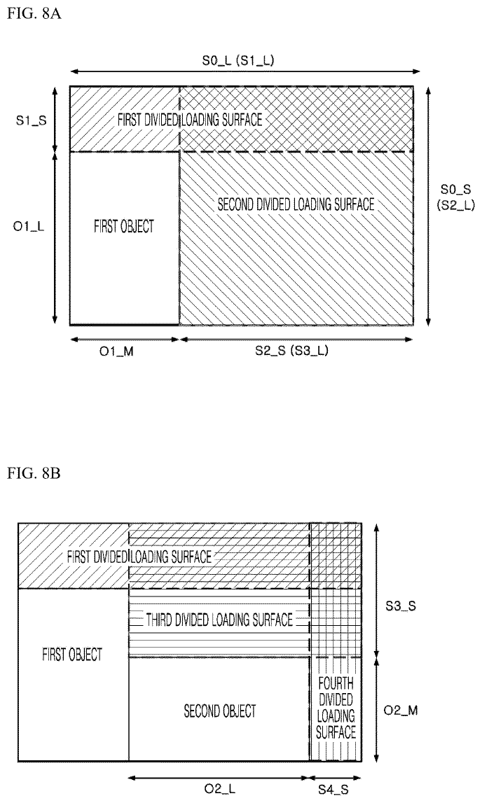

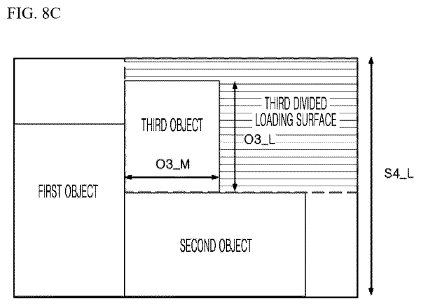

Hereinafter, an object arrangement apparatus and method according to an exemplary embodiment of the present disclosure will be described in detail with reference to FIG. 1, FIG. 2, FIG. 3, FIG. 4, FIG. 5, FIG. 6, FIG. 7, FIG. 8A, FIG. 8B and FIG. 8C.

FIG. 1 is a block diagram of an object arrangement apparatus according to various exemplary embodiments of the present disclosure. Furthermore, FIG. 2 is a flowchart of an object arrangement method according to various exemplary embodiments of the present disclosure.

Referring to FIG. 1, an apparatus 100 for arranging objects according to various exemplary embodiments of the present disclosure includes a data manager 110, an object data preprocessor 120, an object arranger 130, an object arrangement reviewer 140, an object arrangement visualizer 150, etc.

Herein, in an exemplary embodiment of the present disclosure, the data manager 110, the object data preprocessor 120, the object arranger 130, the object arrangement reviewer 140, the object arrangement visualizer 150, may be implemented with separate processors. Alternatively, the data manager 110, the object data preprocessor 120, the object arranger 130, the object arrangement reviewer 140, the object arrangement visualizer 150 may be implemented with a single integrated processor.

The data manager 110 manages object data and set box data.

The object data is data including detailed information related to objects (e.g., parts), and include information related to identifiers of the objects (e.g., part names and part numbers), sizes of the objects (e.g., lengths, widths, and heights), an arrangement order of the objects (e.g., a work order of the parts), etc. as shown in FIG. 3.

Furthermore, with respect to the size of an object, according to various exemplary embodiments of the present disclosure, in the case of a rectangular virtual object including a minimum volume, which may include the corresponding object, the shortest length of the rectangular virtual object is defined as the height of the object, the longest length of the rectangular virtual object is defined as the length (or width) of the object, and the middle length of the rectangular virtual object is defined as the width (or length) of the object as shown in FIG. 4. Accordingly, the present disclosure enables the object to be stably loaded in a set box by loading a portion of the object corresponding to the maximum area (the longest length x middle length) onto the loading surface of the set box.

Meanwhile, the set box data is data including detailed information related to set boxes, and includes information related to identifiers of the set boxes (e.g., set box names and set box numbers), types of the set boxes (e.g., a general box, a big box, etc.), sizes of the set boxes (e.g., lengths, widths, and heights), etc. as shown in FIG. 5.

The object data preprocessor 120 is configured to determine the type of a set box in which each object is arrangeable based on the object data and the set box data, and is configured to perform preprocessing on the object data as shown in Operation S210 of FIG. 2.

For example, the object data preprocessor 120 compares the sizes of the objects and the sizes of set boxes to determine the type of a set box in which each object is arrangeable, and is configured to perform preprocessing of the object data by including information related to the type of the set box in which the corresponding object is arrangeable in the object data.

In this regard, FIG. 6 is a detailed flowchart showing Operation S210 of FIG. 2, illustrating an object data preprocessing method according to various exemplary embodiments of the present disclosure. For reference, the exemplary embodiment of FIG. 6 is explained on the premise that two types of set boxes, i.e., a first type of set box (e.g., a big box) and a second type of set box (e.g., a normal box) which is smaller than the first type of set box, are used in a corresponding process.

Referring to FIG. 6, in Operation S211, the object data preprocessor 120 receives the object data and the set box data from the data manager 110, and determines the identifier, size, etc. of each object and the types, sizes, etc., of set boxes to be used in the corresponding process.

Furthermore, Operations S212 and S213, the object data preprocessor 120 is configured to determine whether a corresponding object is arrangeable in the set box including the largest size, i.e., the first type of set box.

In Operation S212, the object data preprocessor 120 compares the height of the object with the loadable height of the first type of set box, and if the height of the object is greater than the loadable height of the first type of set box, is configured to determine that the corresponding object is not arrangeable (not loadable) in the set boxes in Operation S214.

On the other hand, if the height of the object is not greater than the loadable height of the first type of set box, the object data preprocessor 120 compares the longest length of the object with the longest length of the loading surface of the first type of set box and/or compares the middle length of the object with the shortest length of the loading surface of the first type of set box in Operation S213, and if the longest length of the object is greater than the longest length of the loading surface of the first type of set box or the middle length of the object is greater than the shortest length of the loading surface of the first type of set box, the object data preprocessor 120 is also configured to determine that the corresponding object is not arrangeable (not loadable) in the first type of set box in Operation S214.

On the other hand, if the shortest length of the object is not greater than the loadable height of the first type of set box, the longest length of the object is not greater than the longest length of the loading surface of the first type of set box, and the middle length of the object is not greater than the shortest length of the loading surface of the first type of set box, the object data preprocessor 120 is configured to determine that the corresponding object is arrangeable in the first type of set box, and is configured to perform a next operation to determine whether the corresponding object is arrangeable in the second type of set box, which is one step smaller than the first type of set box.

Accordingly, in Operations S215 and S216, the object data preprocessor 120 is configured to determine whether the corresponding object is arrangeable in the second type of set box.

In Operation S215, the object data preprocessor 120 compares the height of the object with the loadable height of the second type of set box, and if the height of the object is greater than the loadable height of the second type of set box, is configured to determine that the corresponding object is arrangeable (loadable) only in the first type of set box in Operation S217.

On the other hand, if the height of the object is not greater than the loadable height of the second type of set box, the object data preprocessor 120 compares the longest length of the object with the longest length of the loading surface of the second type of set box and/or compares the middle length of the object with the shortest length of the loading surface of the second type of set box in Operation S216, and if the longest length of the object is greater than the longest length of the loading surface of the second type of set box or the middle length of the object is greater than the shortest length of the loading surface of the second type of set box, the object data preprocessor 120 is also configured to determine that the corresponding object is arrangeable (loadable) only in the first type of set box in Operation S217.

On the other hand, if the shortest length of the object is not greater than the loadable height of the second type of set box, the longest length of the object is not greater than the longest length of the loading surface of the second type of set box, and the middle length of the object is not greater than the shortest length of the loading surface of the second type of set box, the object data preprocessor 120 is configured to determine that the corresponding object is arrangeable (loadable) in both the first type of set box and the second type of set box in Operation 218.

Finally, in Operation S219, the object data preprocessor 120 updates the object data by including information on the types of set boxes in which the corresponding object is arrangeable in the object data.

For reference, the exemplary embodiment of FIG. 6 illustrates the preprocessing method for the object data on the premise that two types of set boxes are used in the corresponding process, but even if three or more types of set boxes are used in the corresponding process, preprocessing for the object data may be performed in a similar manner (for example, determining whether a corresponding object is arrangeable in the largest set box and then sequentially determining whether the object is arrangeable in a set box which is one step smaller than the largest set box).

Furthermore, in the exemplary embodiment of FIG. 6, when determining whether the corresponding object is arrangeable in one type of set box, determination on the loadable height of the set box is first performed as shown in Operations S212 and S215 and then determination on the loading surface of the set box is performed as shown in Operations S213 and S216, but in the instant case, the order of determination is not important and it is of course possible to implement all determinations in one operation.

Referring again to FIG. 1 and FIG. 2, the object arranger 130 is configured to determine a set box in which the corresponding object is to be arranged depending on the arrangement order of the objects, based on the preprocessed object data and the set box data, and is configured to perform arrangement of the corresponding object in the determined set box as shown in Operation S220 of FIG. 2.

For example, the object arranger 130 is configured to determine types of set boxes in which the corresponding object is arrangeable depending on the arrangement order of the objects included in the object data, determines a type of set box in which object arrangement is currently in progress and an object arrangement state of the set box, is configured to determine a set box in which the corresponding object is to be arranged and an arrangement position of the corresponding object in the set box using a predetermined object arrangement algorithm, and is configured to perform object arrangement for the corresponding set box.

In this regard, FIG. 7 is a detailed flowchart showing Operation S220 of FIG. 2, illustrating an object arrangement method according to various exemplary embodiments of the present disclosure. For reference, the exemplary embodiment of FIG. 7 is explained on the premise that two types of set boxes, i.e., a first type of set box (e.g., a big box) and a second type of set box (e.g., a normal box) which is smaller than the first type of set box, are used in a corresponding process.

Referring to FIG. 7, in Operation S221, the object arranger 130 receives the preprocessed object data and the set box data from the data manager 110, and determines the identifier, sizes, arrangement order, the types of set boxes in which the objects are arrangeable etc., of the objects, and the types, sizes, number, etc., of set boxes to be used in the corresponding process.

In Operation S222, the object arranger 130, depending on the arrangement order of the objects, is configured to determine that a type of set box in which the object arrangement is currently in progress corresponds to a type of set box in which an object to be currently arranged is arrangeable by comparing the type of the set box in which the object arrangement is currently in progress with the type of the set box in which the object to be currently arranged is arrangeable.

If the type of the set box in which the object arrangement is currently in progress is the set box in which the object to be currently arranged is arrangeable (for example, if the type of the set box in which the object to be currently arranged is arrangeable is the first type and the set box in which the object arrangement is currently in progress is a set box of the first type, or if the types of the set boxes in which the object to be currently arranged is arrangeable are the first type and the second type and the set box in which the object arrangement is currently in progress is a set box of the first type or the second type), the object arranger 130 is configured to determine whether the object to be currently arranged is arrangeable in the set box in which the object arrangement is currently in progress based on the predetermined object arrangement algorithm in Operation S223.

If the object to be currently arranged is arrangeable in the set box in which the object arrangement is currently in progress, in Operation S224, the object arranger 130 arranges the object to be currently arranged at an arrangement position in the set box in which the object arrangement is currently in progress based on the object arrangement algorithm, and updates the object arrangement state of the set box in which the object arrangement is currently in progress.

Thereafter, in Operation S226, the object arranger 130 confirms whether arrangement of all objects required for the corresponding process has been completed, and if arrangement of all objects required for the corresponding process has not been completes, returns to Operation S222, and is configured to perform arrangement of an object which is next in the arrangement order of the objects.

On the other hand, in Operation S222, if the type of the set box in which the object arrangement is currently in progress is not the set box in which the object to be currently arranged is arrangeable (for example, if the type of the set box in which the object to be currently arranged is arrangeable is the first type and the set box in which the object arrangement is currently in progress is a set box of the second type), in Operation S225, the object arranger 130 terminates the object arrangement of the set box in which the object arrangement is currently in progress, and selects a new set box in which the object to be currently arranged is arrangeable (for example, a set box of the first type). Accordingly, the object arranger 130 arranges the object to be currently arranged at an arrangement position in the new set box in which the object arrangement is currently in progress, determined based on the object arrangement algorithm, and updates the object arrangement state of the new set box.

On the other hand, in Operation S223, if the object to be currently arranged is not arrangeable in the set box in which the object arrangement is currently in progress (for example, the set box in which the object arrangement is currently in progress corresponds to the type of the set box in which the object to be currently arranged is arrangeable, but the object to be currently arranged is not configured for being arrangeable in the set box in which the object arrangement is currently in progress due to a previously arranged object), in Operation S225, the object arranger 130 also terminates the object arrangement of the set box in which the object arrangement is currently in progress, and selects a new set box in which the object to be currently arranged is arrangeable. Accordingly, the object arranger 130 arranges the object to be currently arranged at an arrangement position in the new set box in which the object arrangement is currently in progress, determined based on the object arrangement algorithm, and updates the object arrangement state of the new set box.

For reference, if the object arranger 130 selects a new set box in which the object to be currently arranged is arrangeable in Operation S225, according to various exemplary embodiments of the present disclosure, the object arranger 130 may select a set box having the smallest size among types of set boxes in which the object to be currently arranged is arrangeable. Accordingly, the present disclosure may increase the filling rate of the set box using the loading space of the set box as efficiently as possible.

Furthermore, according to various exemplary embodiments of the present disclosure, the object arrangement algorithm used when arranging one or more objects in an arbitrary set box is configured to select the smallest area out of the loading surface of the set box, to which a rectangle formed by the longest length and the middle length of the object (i.e., the bottom surface of a virtual rectangular object) belongs, when selecting a space of the set box in which the object is to be arranged, and to arrange the object so that the horizontal or vertical remaining length of the selected area of the loading surface of the set box is minimized.

In this regard, FIG. 8A, FIG. 8B and FIG. 8C are diagrams illustrating the object arrangement algorithm according to various exemplary embodiments of the present disclosure.

Referring to FIG. 8A, FIG. 8B and FIG. 8C, in the case of a first object to be arranged first in a set box, the longest length S0_L and the shortest length S0_S of the loading surface of the set box are compared with the first longest length O1_L and the first middle length O1_M of the first object, respectively, and the first object is arranged on the loading surface of the set box so that the horizontal or vertical remaining length of the loading surface of the set box is minimized.

In the case of the first object, since the case in which the horizontal or vertical remaining length of the loading surface of the set box is minimized is the case in which the first longest length O1_L of the first object is subtracted from the shortest length S0_S of the loading surface of the set box, the first object is arranged at the corner (0,0) of the loading surface of the set box so that a side of the first object having the first longest length O1_L comes into contact with a side of the loading surface of the set box having the shortest length S0_S and another side of the first object having the first middle length O1_M comes into contact with another side of the loading surface of the set box having the longest length S0_L as shown in FIG. 8A).

When the first object has been arranged on the loading surface of the set box, an “L”-shaped remaining space is formed from the end point (O1_M, O1_L) of the rectangular first object, and the space is divided to generate a first divided loading surface (a rectangle indicated by 45 degree diagonal lines in FIG. 8A) and a second divided loading surface (a rectangle indicated by 135 degree diagonal lines in FIG. 8A).

Furthermore, in the case of a second object to be arranged secondarily in the set box, the longest length S1_L and the shortest length S1_S of the first divided loading surface of the set box and the longest length S2_L and the shortest length S2_S of the second divided loading surface of the set box are compared with the second longest length O2_L and the second middle length O2_M of the second object, respectively, and the second object is arranged on one divided loading surface of the set box so that the horizontal or vertical remaining length of the divided loading surface of the set box is minimized.

In the case of the second object, since the case in which the horizontal or vertical remaining length of the divided loading surface of the set box is minimized is the case in which the second longest length O2_L of the second object is subtracted from the shortest length S2_S of the second divided loading surface of the set box, the second object is arranged at the corner (0,O1_M) of the second divided loading surface of the set box so that a side of the second object having the second longest length O2_L comes into contact with a side of the second divided loading surface of the set box having the shortest length S2_S and another side of the second object having the second middle length O2_M comes into contact with another side of the second divided loading surface of the set box having the longest length S2_L as shown in FIG. 8B.

When the second object has been arranged on the second divided loading surface of the set box, an “L”-shaped remaining space is formed again from the end point (O1_M+O2_L, O2_M) of the rectangular second object, and is divided to generate a third divided loading surface (a rectangle indicated by horizontal lines in FIG. 8B and 8C) and a fourth divided loading surface (a rectangle indicated by vertical lines in FIG. 8B), in addition to the existing first divided loading surface (the rectangle indicated by 45 degree diagonal lines in FIG. 8B)

Furthermore, in the case of a third object to be arranged thirdly in the set box, the longest length S1_L and the shortest length S1_S of the first divided loading surface of the set box, the longest length S3_L and the shortest length S3_S of the third di vided loading surface of the set box, and the longest length S4_L and the shortest length S4_S of the fourth divided loading surface of the set box are compared with the third longest length O3_L and the third middle length O3_M of the third object, respectively, and the third object is arranged on one divided loading surface of the set box so that the horizontal or vertical remaining length of the divided loading surface of the set box is minimized.

In the case of the third object, since the case in which the horizontal or vertical remaining length of the divided loading surface of the set box is minimized is the case in which the third longest length O3_L of the third object is subtracted from the shortest length S3_S of the third divided loading surface, the third object is arranged at the corner (O1_M, O2_M) of the third divided loading surface of the set box so that a side of the third object having the third longest length O3_L comes into contact with a side of the third divided loading surface of the set box having the shortest length S3_S and another side of the third object having the third middle length O3_M comes into contact with another side of the third divided loading surface of the set box having the longest length S3_L as shown in FIG. 8C.

In the present way, the present disclosure may arrange one or more objects in an arbitrary set box as efficiently as possible to minimize an empty space, being configured for increasing the filling rate of the set box.

Referring again to FIG. 1 and FIG. 2, the object arrangement reviewer 140 is configured to determine whether all the objects required for the corresponding process are appropriately arranged in one or more set boxes with reference to, for example, a process schedule, or the like as shown in Operation S230 of FIG. 2.

For example, assuming that the total number of objects depending on the process is 19 and the total number of set boxes used to arrange the objects is 4, the object arrangement reviewer 140 is configured to determine whether all the objects required for the corresponding process are arranged in each set box by determining whether all the nineteen objects are arranged in all the four set boxes.

Furthermore, the object arrangement visualizer 150 visualizes arrangement of one or more objects in one or more set boxes so that users may know the arrangement structure of each object in each set box as shown in Operation S240 of FIG. 2.

As is apparent from the above description, according to an exemplary embodiment of the present disclosure, arrangement of objects (e.g., parts) in a set box may be rapidly modeled and optimized, and thus, parts may be flexibly procured in real time in response to a change in object organization for an arbitrary process, and an effect of stabilizing a production process in the flexible production concept may be exhibited.

Furthermore, according to an exemplary embodiment of the present disclosure, a set box in which each object is to be arranged depending on the arrangement order of the objects (e.g., a work order) is determined, and the objects are optimally arranged in the corresponding set box, being configured for smoothly performing work of the corresponding process.

Furthermore, according to an exemplary embodiment of the present disclosure, the objects are arranged to minimize an empty space in the set box using an optimal object arrangement algorithm, being configured for maximizing the filling rate of the set box to reduce the number of set boxes used and to efficiently utilize a work space.

In the specification (in the claims) of the present disclosure, use of the term “above” and similar referential terms may refer to the singular and the plural. Furthermore, when a range is stated in an exemplary embodiment of the present disclosure, the statement includes the present disclosure to which individual values within the range are applied (unless there is a statement to the contrary), and is the same as a statement of the individual values forming the range in the DETAILED DESCRIPTION.

Unless there is a statement of an explicit order or a statement to the contrary regarding steps forming the method according to an exemplary embodiment of the present disclosure, the steps may be performed in any appropriate order. The present disclosure is not necessarily limited by the described order of the steps. Use of any examples or illustrative terms (for example, etc.) in an exemplary embodiment of the present disclosure is merely to describe the present disclosure in detail, and unless limited by the claims, the scope of the present disclosure is not limited by the examples or illustrative terms. Furthermore, those skilled in the art will appreciate that various modifications, combinations, and changes may be made according to design conditions and factors within the scope of the appended claims or their equivalents.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), Silicon Disk Drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An object arrangement apparatus comprising:
a data manager configured to manage object data including information on identifiers, sizes and an arrangement order of objects, and set box data including information on types and sizes of set boxes;
an object data preprocessor configured to determine a type of a set box in which each object is arrangeable, based on the object data and the set box data, and perform preprocessing on the object data; and
an object arranger configured to determine a set box in which an object is arranged depending on the arrangement order of the objects, based on the preprocessed object data and the set box data, and perform arrangement of the object in the determined set box.

2. The object arrangement apparatus of claim 1, further including:
an object arrangement reviewer configured to review whether all objects required for the corresponding process have been arranged in one or more set boxes; and
an object arrangement visualizer configured to visualize arrangement of one or more objects in the one or more set boxes.

3. The object arrangement apparatus of claim 1, wherein the object date preprocessor is further configured to conclude that the object is arrangeable in the set box, in response that a shortest length of the object is not greater than a loadable height of the set box, a longest length of the object is not greater than a longest length of a loading surface of the set box, and a middle length of the object is not greater than a shortest length of the loading surface of the set box, and includes information on the type of the set box in which the object is arrangeable in the object data.

4. The object arrangement apparatus of claim 1, wherein the object arranger is further configured to determine a set box in which each object is to be arranged depending on the arrangement order of the objects and to arrange the object, using an object arrangement algorithm, wherein the object arranger is configured to:
in response that an object to be currently arranged is arrangeable in a set box in which object arrangement is currently in progress, conclude the set box in which the object arrangement is currently in progress as a set box in which the object to be currently arranged is to be arranged, and arranges the object to be currently arranged in determined the set box; and
in response that the object to be currently arranged is not arrangeable in the set box in which the object arrangement is currently in progress, terminate the object arrangement in the set box in which the object arrangement is currently in progress, determine a new set box in which the object to be currently arranged is arrangeable as a set box in which the object to be currently arranged is to be arranged, and arrange the object to be currently arranged in the new set box.

5. The object arrangement apparatus of claim 4, wherein the object arrangement algorithm is configured to, when selecting a space of the set box in which the object is to be arranged, select a smallest area out of a loading surface of the set box, to which a rectangle formed by a longest length and a middle length of the object belongs, and arrange the object so that a horizontal or vertical remaining length of the selected area out of the loading surface of the set box is minimized.

6. An object arrangement method including:
based on object data including information on identifiers, sizes and an arrangement order of objects, and set box data including information on types and sizes of set boxes, determining, by a processor, a type of a set box in which each object is arrangeable and performing preprocessing on the object data; and
determining, by the processor, a set box in which an object is arranged depending on the arrangement order of the objects, based on the preprocessed object data and the set box data, and performing arrangement of the object in the determined set box.

7. The object arrangement method of claim 6, further including:
reviewing, by the processor, whether all objects required for the corresponding process have been arranged in one or more set boxes; and
visualizing, by the processor, arrangement of one or more objects in the one or more set boxes, in response that all the objects required for the corresponding process have been arranged in the one or more set boxes.

8. The object arrangement method of claim 6, wherein the performing of the preprocessing of the object data includes:
determining that the object is arrangeable in the set box, in response that a shortest length of the object is not greater than a loadable height of the set box, a longest length of the object is not greater than a longest length of a loading surface of the set box, and a middle length of the object is not greater than a shortest length of the loading surface of the set box, and including information on the type of the set box in which the object is arrangeable in the object data.

9. The object arrangement method of claim 6, wherein, in the performing of the arrangement of the object, a set box in which each object is to be arranged is determined depending on the arrangement order of the objects, and the object is arranged in the set box, using an object arrangement algorithm, wherein
in response that an object to be currently arranged is arrangeable in a set box in which object arrangement is currently in progress, the set box in which the object arrangement is currently in progress is determined as a set box in which the object to be currently arranged is to be arranged, and the object to be currently arranged is arranged in the determined set box; and
in response that the object to be currently arranged is not arrangeable in the set box in which the object arrangement is currently in progress, the object arrangement in the set box in which the object arrangement is currently in progress is terminated, a new set box in which the object to be currently arranged is arrangeable is determined as a set box in which the object to be currently arranged is to be arranged, and the object to be currently arranged is arranged in the new set box.

10. The object arrangement method of claim 9, wherein the object arrangement algorithm is configured to, when selecting a space of the set box in which the object is to be arranged, select a smallest area out of a loading surface of the set box, to which a rectangle formed by a longest length and a middle length of the object belongs, and arrange the object so that a horizontal or vertical remaining length of the selected area out of the loading surface of the set box is minimized.
